(19) United States
(12) Patent Application Publication
(10) Pub. No.: US 2026/0307775 A1
(43) Pub. Date: Oct. 8, 2026

(54) High-Efficiency UAV Flight Apparatus Integrating Gurney Flap and Distributed Propulsion System

(71) Applicant: National Yang Ming Chiao Tung University, Hsinchu (TW)

(72) Inventors: Kim Boon LUA, Hsinchu (TW); Pin Wei CHIANG, Taichung (TW)

(21) Appl. No.: 19/076,079

(22) Filed: Mar. 11, 2025

(30) Foreign Application Priority Data
Feb. 27, 2025 (TW) 114107392

(51) Int. Cl. B64C 9/00; B33Y 40/20; B33Y 80/00; B64F 5/10; B64U 10/25; B64U 30/10; B64U 50/13

(52) U.S. Cl. CPC B64C 9/00; B33Y 80/00; B64F 5/10; B64U 10/25; B64U 30/10; B64U 50/13; B33Y 40/20

(57) ABSTRACT

The present invention relates to a high-efficiency UAV flight apparatus that integrates a Gurney flap with a distributed propulsion system. By introducing the Gurney flap into the distributed propulsion system, this invention improves aerodynamic efficiency and enhances the overall performance of the propulsion system, thereby addressing the efficiency limitations present in existing UAV systems.

### BACKGROUND OF THE INVENTION

### 1. Field of the Invention

The present invention relates to an unmanned aerial vehicle (UAV) flight apparatus, more particularly to an unmanned aerial vehicle (UAV) flight apparatus integrating a Gurney flap and a distributed propulsion system.

### 2. Description of the Prior Art

The “airfoil”, also referred to as the “wing profile”, represents the cross-sectional shape of rotors, propellers, turbines, wings, and sails. The geometric design of an airfoil influences the aerodynamic forces generated within a fluid, altering airflow direction to produce lift and drag. For example, by adjusting the angle of attack (AOA), an airfoil can increase lift to counteract gravity, suitable for applications such as aircraft wings and rotors that require lift generation. A Gurney flap is a small additional structure installed at the trailing edge of an airfoil, effectively increasing the lift coefficient and enhancing aerodynamic performance, particularly suitable for applications requiring high lift and improved lift efficiency, such as race car wings, wind turbine blades, and airfoil designs for fixed-wing or rotary-wing aircraft.

In US20180162515, which is related to a Gurney Flap System. This patent covers a Gurney flap arrangement, focusing on retractable and deployable mechanisms of the Gurney flap within an airfoil, such as for rotary wing aircraft. It addresses how the Gurney flap improves aerodynamic efficiency by increasing lift and reducing drag. In U.S. Pat. No. 9,751,614, which is related to an aeroelastic wing shaping using distributed propulsion. This patent from NASA addresses wing shaping using distributed propulsion. It covers adaptive wing technologies that continuously optimize aerodynamic performance by adjusting the wing's shape during flight. In CN109436316A, which is related to a kind of Gurney flap drive system for variable-speed rotor. This patent focuses on Gurney flap systems designed for adaptive speed rotorcrafts. It highlights a mechanism that adjusts the Gurney flap based on varying rotor speeds to enhance aerodynamic control. In US20180162515A1, which is related to a Gurney flap system. This patent deals with a retractable Gurney flap that integrates with an airfoil, designed for enhanced control and aerodynamic performance. There are currently no existing patents that specifically address the application of Gurney flaps to enhance the aerodynamic performance of wings in distributed propulsion systems. This represents a new concept and innovation.

Basso, M.; Cravero, C.; Marsano, D. Aerodynamic Effect of the Gurney Flap on the Front Wing of a F1 Car and Flow Interactions with Car Components. Energies 2021, 14, 2059, the study focused on how Gurney flaps improved the downforce in the front wing of a Formula 1 car, leading to significant performance gains. This shows that Gurney flaps are widely applied to enhance aerodynamic efficiency across various fields. Another, Wu, J.; Gao, F.; Li, S.; Yang, F. Conceptual Design and Optimization of Distributed Electric Propulsion General Aviation Aircraft. Aerospace 2023, 10, 387, which a widely research into the optimization of DEP systems, particularly in general aviation, examined the interactions between propeller slipstreams and wings. This study showed how distributed propulsion can improve range and efficiency in aviation, particularly when coupled with aerodynamic modifications. Here, there are currently no existing papers that specifically address the application of Gurney flaps to enhance the aerodynamic performance of wings in distributed propulsion systems, also, represents a new concept and innovation.

According to the abovementioned, in fact, distributed propulsion (DP) systems have gained significant attention in recent years, particularly in the development of unmanned aerial vehicles (UAVs). These systems feature multiple small propellers distributed along the leading edge of the wing, enabling short or vertical takeoff and landing capabilities. While distributed propulsion (DP) systems increase the lift generated by the aircraft, they exhibit several notable inefficiencies:

Cruise Inefficiency: distributed propulsion (DP) systems are effective in generating high lift at low speeds, especially during takeoff and landing. However, at higher speeds and during cruise conditions, the interaction between the propeller slipstream and the wing surface becomes complex. This complexity can lead to increased drag, ultimately reducing the overall aerodynamic efficiency of the aircraft. As a result, the cruising efficiency of distributed propulsion (DP)-equipped aircraft is limited.

Limited Lift-to-Drag Ratio Improvement: Although distributed propulsion (DP) enhances the lift of the airfoil, it does not significantly improve the lift-to-drag ratio across all flight conditions. Particularly at higher Reynolds numbers, the induced drag from propeller interactions often offsets the benefits of increased lift. This makes the system quite less efficient during a cruise flight.

In other words, while existing distributed propulsion systems successfully enhance lift through distributed propellers, existing distributed propulsion systems frequently encounter complex interactions between propeller slipstream and the wing surface under cruise conditions, which can significantly reduce efficiency. These challenges lead to increased aerodynamic drag, further limiting overall aerodynamic performance during high-speed flight.

The aforementioned limitation will highlight the need for further improvements in distributed propulsion systems to enhance flight efficiency across a broader range of flight conditions. Moreover, no existing research has explicitly disclosed the application of Gurney flaps to enhance the aerodynamic performance of distributed propulsion wings. Therefore, if Gurney flaps are successfully implemented to improve the aerodynamic performance of distributed propulsion wings, Gurney flaps would represent the groundbreaking advancement in both a Gurney flap technology and a distributed propulsion wing development, making the Gurney flap a highly anticipated innovation within the industry.

### SUMMARY OF THE INVENTION

The present invention relates to an unmanned aerial vehicle (UAV) flight apparatus integrating a Gurney flap (GF) and a distributed propulsion system. The present invention focuses on enhancing aerodynamic efficiency and overall propulsion system performance by introducing a Gurney flap into the distributed propulsion system, thereby addressing the efficiency limitations present in existing distributed propulsion unmanned aerial vehicle (UAV) systems.

The unmanned aerial vehicle (UAV) flight apparatus integrating a Gurney flap and a distributed propulsion system, which comprises a Gurney flap, a fixed wing, and multiple distributed propulsion systems. Thus, the assembly process involves the following: providing a fixed wing, equipping multiple distributed propulsion systems, which are positioned along the leading edge of the fixed wing, and installing the Gurney flap at the trailing edge of the fixed wing.

One of the advantages of the unmanned aerial vehicle (UAV) flight apparatus integrating a Gurney flap and a distributed propulsion system of the present invention, which focuses on the integration of Gurney flaps with distributed propulsion (DP) systems to address the inefficiencies present in current DP configurations.

One of the advantages of the unmanned aerial vehicle (UAV) flight apparatus integrating a Gurney flap and a distributed propulsion system of the present invention, which is by combining the enhanced lift characteristics of Gurney flaps with the distributed thrust generated by distributed propulsion (DP) systems, this invention aims to optimize both lift and drag, thereby improving overall aerodynamic performance.

One of the advantages of the unmanned aerial vehicle (UAV) flight apparatus integrating a Gurney flap and a distributed propulsion system of the present invention, the field of this invention pertains to the enhancement of aerodynamic performance in unmanned aerial vehicle (UAV) flight apparatus and small aircraft.

One of the advantages of the unmanned aerial vehicle (UAV) flight apparatus integrating a Gurney flap and a distributed propulsion system of the present invention, specifically, the invention integrates distributed propulsion (DP) systems and Gurney flaps to improve the lift-to-drag ratio.

One of the advantages of the unmanned aerial vehicle (UAV) flight apparatus integrating a Gurney flap and a distributed propulsion system, this integration of the invention enables more efficient flight in low-speed, high-lift scenarios while reducing drag during cruise conditions. Such enhancements are crucial for both vertical takeoff and landing (VTOL) and short takeoff and landing (STOL) unmanned aerial vehicle (UAV) flight apparatus applications, allowing for greater operational versatility.

One of the advantages of the unmanned aerial vehicle (UAV) flight apparatus integrating a Gurney flap and a distributed propulsion system of the invention, which is to overcome the inherent inefficiencies found in current electric propulsion (DEP) systems, by incorporating Gurney flaps, which are recognized for their ability to enhance lift while controlling drag, the invention seeks to improve the lift-to-drag ratio.

One of the advantages of the unmanned aerial vehicle (UAV) flight apparatus integrating a Gurney flap and a distributed propulsion system of the invention, the enhancement of the invention mitigates the negative impacts of propeller slipstream interactions, thus increasing cruising efficiency.

One of the advantages of the unmanned aerial vehicle (UAV) flight apparatus integrating a Gurney flap and a distributed propulsion system of the invention, an unmanned aerial vehicle (UAV) flight apparatus can achieve higher efficiency, extended range, and improved overall performance, especially for small-scale aircraft operating in urban or restricted environments.

### BRIEF DESCRIPTION OF THE DRAWINGS

The foregoing aspects and advantages of this invention will become more apparent from the following detailed description, in conjunction with the accompanying drawings, wherein:

FIG. 1 illustrates the unmanned aerial vehicle (UAV) flight apparatus integrating a Gurney flap and a distributed propulsion system according to the present invention.

FIG. 2 is a cross-sectional view of a NACA airfoil equipped with a Gurney flap and a distributed propulsion system.

FIG. 3A presents the overall flow field and vorticity contour around the airfoil of the present invention.

FIG. 3B is a magnified view of the flow field and vorticity contour near the trailing edge of the airfoil in the present invention.

FIG. 4A shows the variation of the system lift coefficient (CLsys) with angle of attack (AOA) for a NACA 4415 airfoil equipped with a distributed propulsion system under different Gurney flap configurations.

FIG. 4B shows the variation of the system thrust coefficient (CTsys) with angle of attack (AOA) for a NACA 4415 airfoil equipped with a distributed propulsion system under different Gurney flap configurations.

### DESCRIPTION OF THE PREFERRED EMBODIMENT

The unmanned aerial vehicle (UAV) flight apparatus integrating a Gurney flap (GF) and a distributed propulsion (DP) system of the present invention is designed to address critical inefficiencies in existing distributed propulsion systems, particularly during high-speed and cruise phases, by enhancing lift generation and aerodynamic performance.

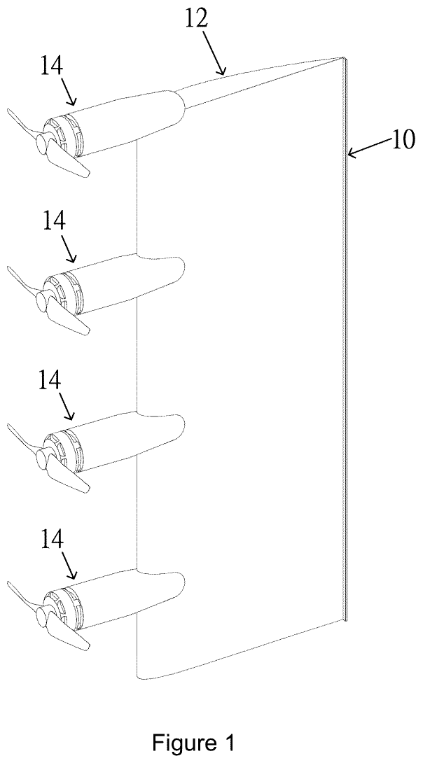

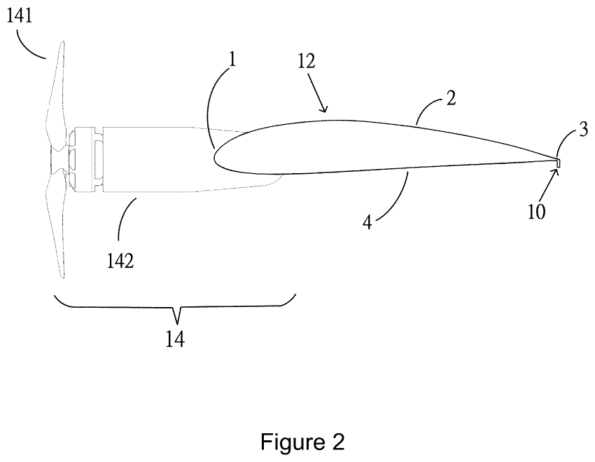

As illustrated in FIG. 1, the unmanned aerial vehicle (UAV) flight apparatus integrating a Gurney flap and a distributed propulsion system comprises: Gurney flap 10, fixed wing 12, and a plurality of distributed propulsion systems 14, wherein the plurality of distributed propulsion systems 14 are composed of a plurality of each single distributed propulsion system 14, also shown in FIG. 2, which is a cross-sectional view of a NACA airfoil equipped with a Gurney flap and a distributed propulsion system, each single distributed propulsion system 14 includes propeller 141 and motor support nacelle 142. The combination method of the present invention is to firstly provide fixed wing 12, and then the plurality of distributed propulsion systems 14 are distributed and installed along the leading edge of fixed wing 12. The Gurney flap 10 is then installed on the trailing edge of fixed wing 12.

Still as shown in FIG. 1, the present invention is an unmanned aerial vehicle (UAV) flight apparatus integrating a Gurney flap and a distributed propulsion system, wherein Gurney flap 10 is a long thin flat plate structure installed on the pressure side of the trailing edge of fixed wing 12 and perpendicular to the chord length. The “chord length” refers to the straight-line distance between the leading edge and the trailing edge of an aircraft wing or other airfoil component. In addition, the “chord length” is one of the most basic parameters in the geometric description of an airfoil, which is usually used to calculate important aerodynamic parameters such as lift coefficient and angle of attack. In the present invention, Gurney flap 10 is installed perpendicular to the “chord length”, which means that the installation direction of Gurney flap 10 is at right angles to the airflow direction of the wing.

Still shown in FIG. 1, the main function of Gurney flap 10 is to increase the lift by increasing the effective curvature of the airfoil and improving the pressure difference between the upper and lower surfaces of the airflow. At the same time, behind Gurney flap 10, the reflow area formed therein assists to stabilize the pressure distribution. In addition, Gurney flap 10 can suppress flow separation on the suction surface to a certain extent, thereby improving the airflow attachment performance. Despite Gurney flap 10 is a small size, Gurney flap 10 significantly can change the airflow distribution at the trailing edge of fixed wing 12, optimizes the aerodynamic performance of fixed wing 12 in distributed electric propulsion technology, and improves the lift-to-drag ratio (L/D) under certain conditions. Due to simplicity and high efficiency of a Gurney flap, so that a Gurney flap is an effective apparatus to improve the aerodynamic efficiency of fixed-wing aircraft.

Continuing with illustrated in FIG. 1, the unmanned aerial vehicle (UAV) flight apparatus integrating a Gurney flap and a distributed propulsion system comprises: as shown in FIG. 1, fixed wing 12 is a NACA airfoil (NACA 4415 wing). Please also refer to FIG. 2, which is a cross-sectional view of the NACA airfoil having a Gurney flap and a distributed propulsion system, wherein the configuration includes: leading edge 1, upper surface 2, trailing edge 3, and lower surface 4.

Please refer to the NACA4415 airfoil cross-section shown in FIG. 2, leading edge 1 is a smooth curve, gradually transitioning to be formed as convex upper surface 2.

Still referring to the NACA4415 airfoil cross-section shown in FIG. 2, upper surface 2 extends from leading edge 1 to trailing edge 3 along a gentle convex arc.

Please refer to the NACA4415 airfoil cross-section shown in FIG. 2, trailing edge 3 is located at the end of the airfoil, and trailing edge 3 has a sharp shape, which is tapered profile to ensure a good aerodynamic flow field.

Referring again to the NACA4415 airfoil cross-section shown in FIG. 2, lower surface 4 extends forward from trailing edge 3 along a relatively gentle arc, and finally connects back to leading edge 1 to form a complete airfoil profile.

Please still refer to the NACA4415 airfoil cross-section shown in FIG. 2. The NACA4415 airfoil belongs to the four-digit NACA airfoil family. The meaning of the number “4415” is as follows:

The first number “4” means that the maximum curvature (bend) is 4% of the chord length.

The second number “4” means that the maximum camber occurs at 40% of the chord length (measured from the leading edge).

The last two digits “15” mean that the maximum thickness of the airfoil is 15% of the chord length.

The NACA4415 airfoil design can provide moderate lift and lower drag, and can be suitable for medium and low speed flight applications, such as small aircraft and drones.

In addition, the maximum camber of the NACA4415 airfoil is 4% of the chord length, located at 0.4 chord lengths from the leading edge, while the maximum thickness is 15% of the chord length. Therefore, the NACA 4415 airfoil is selected as the wing airfoil, that is, fixed wing 12 adopted by the present invention, and the curved wing section can have good lift characteristics at low speed and low angle of attack (AOA).

Again, referring to FIG. 2, the shape, curvature and aerodynamic characteristics of the NACA4415 airfoil are described as follows:

Leading edge 1: leading edge 1 is in the shape of an arc, which is rounded leading edge profile, and the design ensures smooth entry of the fluid and reduces the separation effect.

Curve of Upper surface (upward convex curve) 2: upper surface 2 of the airfoil starts from a leading edge arc and owns a steeper lift curvature, which gradually decreases as the chord length be increased.

Trailing edge 3: trailing edge 3 is designed with a sharp shape, which is tapered profile to ensure smooth separation of the boundary layer, reduce resistance and control vortex separation.

Curve of Lower surface (concave curve) 4: lower surface 4 of the airfoil has a relatively gentle curve starting from leading edge 1, forming a slight depression and gradually transitioning to trailing edge 3.

Aero-dynamic performance advantages of NACA4415 airfoil could be the following:
The NACA4415 airfoil has good lift coefficient and low drag characteristics in the low to medium Reynolds number range (105 to 106), and which is suitable for applications such as small aircraft, drones and wind turbine blades. At moderate angles of attack (AOA), the NACA4415 airfoil can provide relatively stable lift and stall-delay, the NACA4415 airfoil is suitable for applications with high flight stability requirements.

The overall manufacturing structural design of the NACA4415 airfoil includes the following detailed descriptions:

The manufacturing method of the NACA4415 airfoil: the wing and the motor support cabin are manufactured by using an additive manufacturing technology, and the printing accuracy reaches 0.2 mm to 0.4 mm, which ensures high precision and surface smoothness.

The manufacturing material of NACA4415 airfoil: polylactic acid (PLA) is selected, which can provide good rigidity and structural integrity.

After the NACA4415 airfoil is completed by the additive manufacturing technology, the NACA4415 airfoil can be polished by a polishing process, be ground by a grind process, and be sprayed by a spraying surface coating process to improve air flow and reduce friction resistance. The internal structure of the NACA4415 airfoil can be constructed by using stainless steel materials, to strengthen and be increased structural rigidity.

The span of the NACA4415 airfoil can reach 400 mm to 420 mm.

The chord length of the NACA4415 airfoil can be reached 140 mm to 160 mm.

Modular design of NACA4415 airfoil: the trailing edge can be replaced, and the sharp trailing edge of the original airfoil can be manufactured by using an additive manufacturing technology, including 1% Gurney flap, 1.5% Gurney flap, and 2% Gurney flap. After the trailing edge is replaced, the effectiveness of the Gurney flap can be tested.

As shown in FIG. 1, The unmanned aerial vehicle (UAV) flight apparatus integrating a Gurney flap (GF) and a distributed propulsion (DP) system of the present invention having a plurality of (or more than one) distributed propulsion systems 14 with smaller diameters distributed on the leading edge of the wing, aiming to optimize aerodynamic and propulsion performance through distributed propulsion technology. The plurality of propellers 141 can increase the dynamic pressure on the wing surface by accelerating the airflow, thereby improving the lift coefficient, especially performing well during takeoff and low-speed flight. Therefore, a plurality of (or more than one) distributed propulsion systems 14 are installed at the leading edge of the fixed wing 12, and Gurney flap 10 is installed at the trailing edge of the fixed wing 12.

Still referring to FIG. 1, in the unmanned aerial vehicle (UAV) flight apparatus of the present invention, a plurality of (or more than one) distributed propulsion systems 14 are distributed along the leading edge of fixed wing 12, and Gurney flap 10 is installed at the trailing edge of fixed wing 12, and height of Gurney flap 10 is 1% to 2% of the chord length. As shown in FIG. 1, the plurality of (or more than one) distributed propulsion systems 14 include but are not limited to four, also may include a plurality of (or more than one) distributed propulsion systems 14.

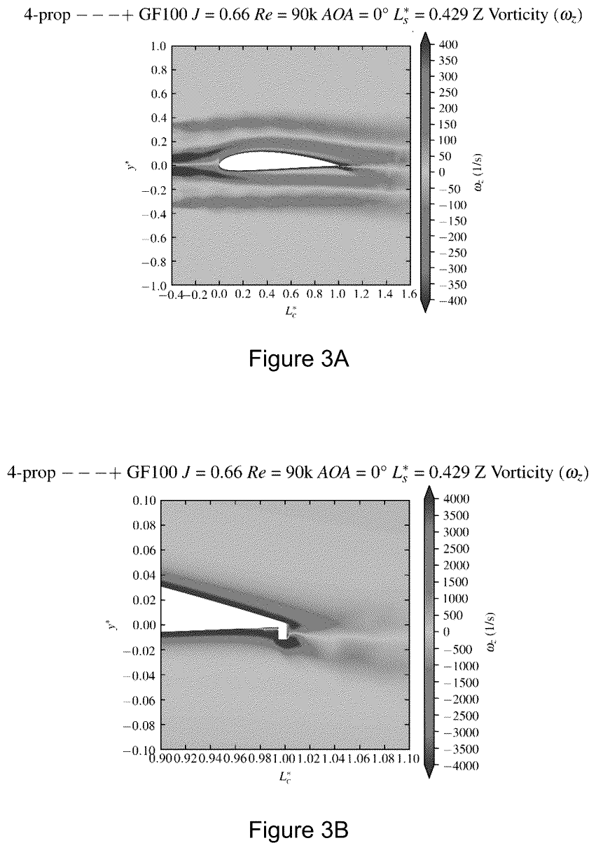

FIG. 3A shows overall flow field and vorticity cloud diagram around the airfoil of the present invention, wherein the size of Gurney flap is 1% of the chord length, which can significantly change the airflow structure at the trailing edge, increase the pressure difference between the upper and lower surfaces of the airfoil, and thus improve the lift-to-drag ratio of a Gurney flap. The vorticity contour shows the interaction of the propeller slipstream with the airflow around the airfoil, especially near the trailing edge of the airfoil, which enhances the flow dynamics and pressure distribution. The presence of a Gurney flap not only changes the “wake structure”, but also, affects overall flow field around the airfoil by stabilizing and adjusting the airflow, assisting to improve the aerodynamic performance of the unmanned aerial vehicle (UAV) flight apparatus.

Moreover, FIG. 3B is an enlarged view of the flow field and vorticity cloud diagram at the trailing edge of the airfoil of the present invention, which illustrates the vortex structure generated by a Gurney flap near the trailing edge. A Gurney flap can generate obvious recirculation areas and vortices near the trailing edge. These vortices change the downstream airflow distribution, further improving the lift coefficient and overall aerodynamic performance of the airfoil. The slipstream of propeller interacts with the vortex generated by a Gurney flap, increasing the dynamic pressure on the airfoil and enhancing circulation control, especially at low speeds and high angles of attack, assisting to stabilize the airflow and improve lift. This interaction plays a key role in improving the aerodynamic efficiency and low-speed performance of the distributed propulsion system, thereby achieving a synergistic enhancement of higher system propulsion efficiency and aerodynamic performance.

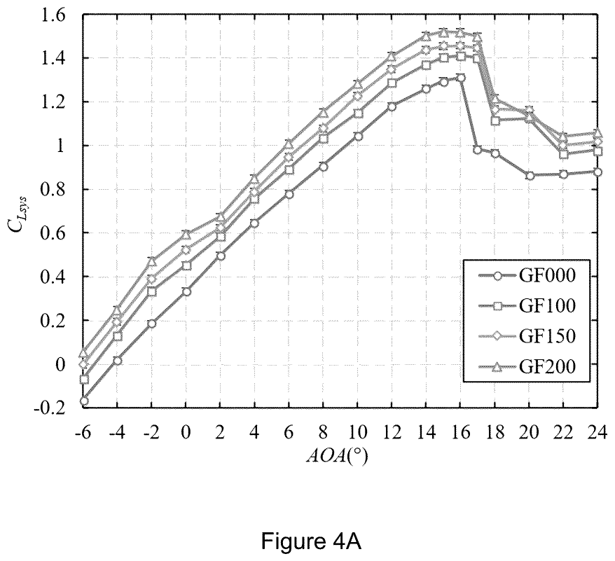

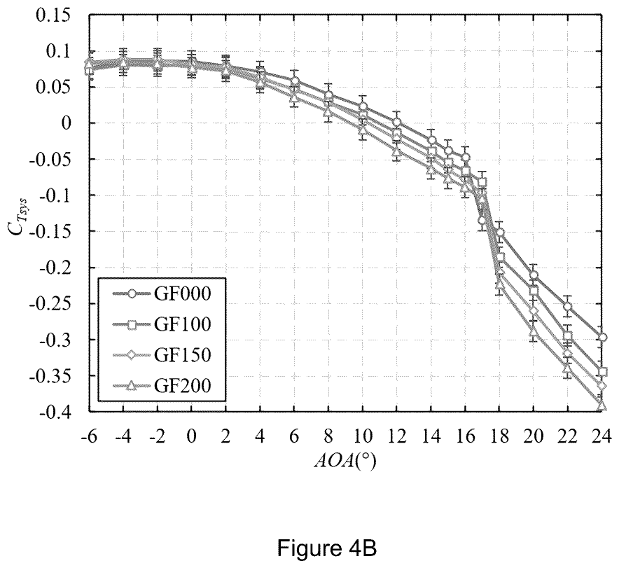

FIG. 4A shows the variation of the system lift coefficient (CLsys) of the NACA4415 airfoil equipped with a distributed propulsion system with the angle of attack (AOA) under different Gurney flap configurations. FIG. 4B shows the variation of the system thrust coefficient (CTsys) of the NACA4415 airfoil equipped with a distributed propulsion system with the angle of attack (AOA) under different Gurney flap configurations. As shown in the aforementioned FIG. 4A, and FIG. 4B, when the Reynolds number is set to 90×10³, simulating the operating environment of an unmanned aerial vehicle (UAV) flight apparatus under cruising conditions, the design combining a distributed electric propulsion system with a Gurney flap shows significant improvement in aerodynamic performance. The results show that the system can effectively enhance lift and optimize airflow distribution under appropriate conditions, thereby improving cruise efficiency and achieving a higher lift-to-drag ratio. In addition, the design of the Gurney flap fully utilizes its role in the distributed propulsion system by enhancing fluid dynamic control, optimizing lift generation and wake management. The interaction of the propeller slipstream with the Gurney flap is critical to improving the performance of the system under a variety of flight conditions, further highlighting the design potential for optimizing unmanned aerial vehicle (UAV) flight apparatus aerodynamic efficiency.

In addition, the graphs of FIG. 4A, and FIG. 4B, above can show the aerodynamic performance results of the NACA4415 airfoil equipped with a distributed propulsion (DP) system under different Gurney flap (GF) configurations. For example, GF000 indicates that no Gurney flap is installed, while GF100, GF150 and GF200 correspond to Gurney flaps with a height of 1%, 1.5% and 2% of the chord length, respectively. In addition, FIG. 3A shows the variation of the system lift coefficient (CLsys) with the angle of attack (AOA), while FIG. 3B shows the system thrust coefficient (CTsys), which is the net thrust generated by the propeller minus the drag acting on the wing. Since the thrust generated by the propeller is fixed, at this time, any reduction in the system thrust coefficient directly indicates an addition in the drag of the wing.

The following describes the characteristics and advantages of the distributed propulsion technology in the unmanned aerial vehicle (UAV) flight apparatus integrating a Gurney flap and a distributed propulsion system:

Distributed propulsion (DP), and specifically distributed electric propulsion (DEP), is increasingly viewed as a breakthrough in unmanned aerial vehicle (UAV) flight apparatus and aircraft design. Distributed electric propulsion (DEP) involves distributing smaller electric motors and propellers along the wingspan, offering substantial advantages in terms of lift and control, especially during takeoff, landing, and low-speed flight phases. NASA has led significant research efforts in this area with projects like “LEAP Tech” and the “X-57 Maxwell”, both of which have demonstrated how distributed propellers can substantially improve the aerodynamic efficiency of wings, enhancing lift and reducing drag.

A major advantage of distributed propulsion (DP) systems is their ability to generate distributed airflow over the wing's surface, increasing lift and delaying stall. By placing propellers along the leading edge of the wing, the airflow over the wing is accelerated, leading to higher pressure differential between the upper and lower surfaces. This results in a significantly improved lift coefficient, particularly during low-speed operations such as vertical or short takeoff and landing (VTOL or STOL). NASA's research has shown that this configuration can achieve a lift coefficient exceeding 5, far higher than traditional fixed-wing designs. Moreover, by utilizing smaller propellers, distributed propulsion (DP) systems can reduce drag during cruising, thereby improving the overall lift-to-drag ratio and enhancing cruising efficiency.

In summary, distributed propulsion marks a significant advancement in aircraft design, offering enhanced lift performance, better control during takeoff and landing, and increased operational versatility. As advancements in battery and electric motor technologies continue to evolve, the full potential of distributed electric propulsion (DEP) systems is expected to be realized, especially in long-range, energy-efficient, and low-emission aircraft. This technology will play a pivotal role in the future of sustainable aviation.

Additionally, the following describes the characteristics and advantages of the Gurney flap technology in the unmanned aerial vehicle (UAV) flight apparatus integrating a Gurney flap and a distributed propulsion system:

Gurney flap is a small, vertical plate added to the trailing edge of an airfoil and is typically less than 3% of the airfoil chord length. Despite simplicity of Gurney flap, the Gurney flap has a significant impact on the aerodynamic performance of an airfoil, particularly in enhancing lift at low angles of attack. When installed, the Gurney flap modifies the airflow near the trailing edge, increasing the pressure differential between the upper and lower surfaces of the airfoil. This results in a higher lift co-efficient and improved overall efficiency, particularly for low-speed flight conditions.

The airflow above the airfoil's suction side remains smooth, while the airflow under the airfoil's pressure side is blocked by the Gurney flap, leading to the formation of a wake region in front of the flap. This redirection of airflow increases the downwash behind the trailing edge, further enhancing lift. At low angles of attack, studies have shown that the lift-to-drag ratio can be significantly improved with the Gurney flap, especially when it is optimally sized relative to the airfoil chord.

Therefore, the key advantages of the unmanned aerial vehicle (UAV) flight apparatus integrating a Gurney flap and a distributed propulsion system in the present invention are described as follows:

### 1. Optimized Lift-to-Drag Ratio:

The integration of Gurney flaps with distributed propulsion (DP) systems optimizes the lift-to-drag ratio by effectively managing airflow at various angles of attack. Positioned at the trailing edge, the Gurney flap increases lift by enhancing the pressure differential between the upper and lower surfaces of the wing. This contributes to maintaining laminar flow and reducing drag penalties, especially at low speeds, without compromising the aerodynamic efficiency of the distributed propulsion system. This balance leads to superior performance during both takeoff and cruising phases.

### 2. Enhanced Cruise Efficiency:

A major limitation of conventional distributed propulsion (DP) systems is the reduction in efficiency at cruising speeds due to increased drag from distributed propellers. The Gurney flap directly addresses this issue by stabilizing airflow at the trailing edge, ensuring a consistently high lift-to-drag ratio during cruise. By mitigating adverse drag effects, the system significantly boosts energy efficiency and overall flight performance, particularly for long-duration and high-speed operations. This improvement makes the system ideal for applications where endurance and fuel efficiency are crucial.

### 3. Reduced Aerodynamic Drag at High Angles of Attack:

The Gurney flap strategically modifies the wake dynamics behind the wing, leading to a more streamlined flow field and reducing drag even at higher angles of attack or cruising speeds. By improving flow stability and reducing turbulence in the propeller slipstream, this configuration enhances energy efficiency, allowing the unmanned aerial vehicle (UAV) flight apparatus to achieve longer flight ranges. The reduction in drag at high speeds is especially important for optimizing UAV performance in extended cruise operations, where minimizing energy loss is critical.

### 4. Scalable and Adaptable Design:

The combined Gurney flap and DP system is highly flexible, allowing it to be scaled and adapted to different unmanned aerial vehicle (UAV) flight apparatus sizes and configurations. This versatility is beneficial for both civilian and military applications, where the system can be tailored to optimize short or vertical takeoff and landing (STOL/VTOL) capabilities while enhancing cruise performance. The adaptability of this design makes it a robust solution for a wide range of mission profiles, from urban air mobility to tactical unmanned systems.

It is understood that various modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled-in-the-art to which this invention pertains.

What is claimed is:

1. An unmanned aerial vehicle flight apparatus, comprising:
a fixed wing, wherein said fixed wing comprising a NACA4415 airfoil;
a Gurney flap, wherein said Gurney flap being a long thin flat plate structure, installed on a pressure side of a trailing edge of said fixed wing, perpendicular to a chord length; and
a plurality of distributed propulsion systems, wherein said plurality of distributed propulsion systems being composed of a plurality of every single distributed propulsion system, and said plurality of distributed propulsion systems are distributed and installed along a leading edge of said fixed wing.

2. The apparatus according to claim 1, wherein a shape of said NACA4415 airfoil, comprising:
a leading edge, said leading edge being in a rounded leading edge profile, and a design ensuring smooth entry of a fluid and reducing a separation effect;
a curve of an upper surface, said upper surface of an airfoil starting from a leading edge arc and having a steeper lift curvature, gradually decreasing as a chord length being increased;
a trailing edge, said trailing edge is designed with a tapered profile to ensure a smooth separation of a boundary layer, reducing resistance and control vortex separation; and
a curve of a lower surface, said lower surface of said airfoil having a relatively gentle curve starting from leading edge, forming a slight depression and gradually transitioning to said trailing edge.

3. The apparatus according to claim 1, wherein said every single distributed propulsion system comprises a propeller and a motor support nacelle.

4. The apparatus according to claim 1, wherein a manufacturing method for a NACA4415 airfoil, comprising:
selecting polylactic acid as a manufacturing material of a NACA4415 airfoil, and an internal structure of said NACA4415 airfoil being made of a stainless steel material;
using an additive manufacturing technology to manufacture a wing and a motor support cabin, wherein an additive manufacturing accuracy reaches 0.2 mm to 0.4 mm; and
after said additive manufacturing technology being completed, performing a polishing process, a grinding process, and a spraying surface coating process.

5. The apparatus according to claim 1, wherein said NACA4415 airfoil comprises using a modular design and said trailing edge being replaced, said trailing edge of said NACA4415 being manufactured by an additive manufacturing technology, being selected from a group consisting of 1% Gurney flap, 1.5% Gurney flap, and 2% Gurney flap.

6. An unmanned aerial vehicle flight apparatus having a Gurney flap and a distributed propulsion system, comprising:
a fixed wing, wherein said fixed wing comprising a NACA4415 airfoil;
a Gurney flap, wherein said Gurney flap being a long thin flat plate structure, installed on a pressure side of a trailing edge of said fixed wing, perpendicular to a chord length; and
a plurality of distributed propulsion systems, wherein said plurality of distributed propulsion systems being composed of a plurality of every single distributed propulsion system, said plurality of distributed propulsion systems are distributed installed along a leading edge of said fixed wing.

7. The apparatus according to claim 6, wherein a shape of said NACA4415 airfoil, comprising:
a leading edge, said leading edge being in a rounded leading edge profile, and a design ensuring smooth entry of a fluid and reducing a separation effect;
a curve of an upper surface, said upper surface of an airfoil starting from a leading edge arc and having a steeper lift curvature, gradually decreasing as a chord length being increased;
a trailing edge, said trailing edge is designed with a tapered profile to ensure a smooth separation of a boundary layer, reducing resistance and control vortex separation; and
a curve of a lower surface, said lower surface of said airfoil having a relatively gentle curve starting from leading edge, forming a slight depression and gradually transitioning to said trailing edge.

8. The apparatus according to claim 6, wherein said single distributed propulsion system comprises a propeller and a motor support nacelle.

9. The apparatus according to claim 6, wherein a manufacturing method for said NACA4415 airfoil, comprising:
selecting polylactic acid as a manufacturing material for said NACA4415 airfoil, and an internal structure of said NACA4415 airfoil being made of stainless steel material;
using an additive manufacturing technology to manufacture a wing and a motor support cabin, wherein said additive manufacturing accuracy reaches 0.2 mm to 0.4 mm; and
after completing said additive manufacturing technology, performing a polishing process, a grinding process, and a spraying surface coating process.

10. The apparatus according to claim 6, wherein said NACA4415 airfoil being of modular design and said trailing edge being able to be replaced, said trailing edge of said NACA4415 is manufactured by an additive manufacturing technology, being selected from a group consisting of 1% Gurney flap, 1.5% Gurney flap, and 2% Gurney flap.
